(19) United States
(12) Patent Application Publication
(10) Pub. No.: US 2025/0043123 A1
(43) Pub. Date: Feb. 6, 2025

(54) Compositions, Vulcanizates, and Cure Processes

(71) Applicant: EXXONMOBIL CHEMICAL PATENTS INC., Baytown, TX (US)

(72) Inventors: Paul Tu Quang NGUYEN, League City, TX (US); Sunny JACOB, Seabrook, TX (US); Edward J. BLOK, Huffman, TX (US)

(21) Appl. No.: 18/717,549

(22) PCT Filed: Dec. 13, 2022
(86) PCT No.: PCT/US2022/052677

§ 371 Date: Jun. 7, 2024

Related U.S. Application Data
(60) Provisional application No. 63/292,133, filed on Dec. 21, 2021.

(51) Int. Cl. C08L 23/22

(52) U.S. Cl. CPC C08L 23/22; C08L 2205/03; C08L 2205/06; C08L 2312/04

(57) ABSTRACT

The present disclosure relates to compositions and elastomer cure processes. In at least one embodiment, a composition includes a phenol formaldehyde resin; a bisthiosulfate; and an elastomer comprising (1) a C₄ to C₇ isoolefin-derived monomer, a non-halogenated alkylstyrene monomer, and a halogenated alkylstyrene monomer, or (2) a C₄ to C₇ isoolefin-derived monomer and a halogenated diolefin. In at least one embodiment, a bromine-containing vulcanizate has a Mooney Viscosity (ML, 1+4@100° C.) of 75 to 92; a cross-linking level (MH-ML) of 10 dNm to 19 dNm; a modulus at 300% of 3 MPa to 10 MPa; a anergy at break of 3J to 5J.

### CROSS REFERENCE TO RELATED APPLICATIONS

This application claims priority to and the benefit of U.S. Provisional Application No. 63/292,133, filed Dec. 21, 2021, the disclosure of which is incorporated herein by reference in its entirety.

### FIELD

The present disclosure relates to compositions, vulcanizates thereof, and cure processes.

### BACKGROUND

Curing bladders are commonly used in presses to mold and cure useful articles such as tires. Tire curing bladders are typically inflated with steam, for example, at 200 psi and 190° C., to press the uncured tire outwardly against a negative mold surface. The pressure exerted by the bladder forms the tire into the desired shape for the tread pattern and sidewall configuration. The application of heat and pressure cures the tire to vulcanize the rubbery polymers comprising the tire material.

Tire curing bladders are ordinarily made from butyl rubber crosslinked or vulcanized to form a polymer having good heat stability and physical properties. Indeed, the proper selection of elastomers and compounding materials for the bladder formulation is important in ensuring durability, service life, and efficient curing bladder operations in a tire factory. In particular, butyl rubbers (e.g., isobutylene-isoprene copolymers) are elastomers used in curing bladder formulations due to excellent heat aging resistance, good flex and tear resistance, and impermeability to air, inert gases, and water vapor. Fundamentally, this is due to the superior heat and steam resistance of cured butyl rubber resulting in wide use of cured butyl rubber for high heat resistant applications. However, because of the high temperature and extreme conditions of use along with the repeated expansion and contraction of the tire curing bladder, bladders made from butyl rubbers have a limited useful life.

Low bromine brominated poly(isobutylene-co-par-methylstyrene) (“BIMSM”) has been proposed to be suitable for use as a tire curing bladder at elevated temperature. A vulcanizable mixture of BIMSM containing 0.15 to 0.45 mole percent benzylic bromine and a cure package comprising 1,6-hexamethylene-bis(sodium thiosulfate) (HTS) and zinc oxide has been demonstrated to form a vulcanizate having good physical and aging properties. However, a vulcanizate formed using this cure system displays excessively high modulus values and relatively poor elongation, which deter its use for tire curing bladder applications or other applications that need high elongation properties.

There is a need for improved compositions (and vulcanizates thereof) for providing tire curing bladders having good curing and aging properties while avoiding excessively high modulus values and relatively poor elongation.

References for citing in an information disclosure statement (37 C.F.R. 1.97(h)): WO 2020/005422; U.S. Pat. No. 5,698,640; U.S. 2021/0187886; U.S. 2021/0246242; D. S. Tracy, “Longer Lasting Tire Curing Bladders”, Tire Technology International (1996)

### SUMMARY

The present disclosure relates to compositions, vulcanizates thereof, and cure processes.

In at least one embodiment, a composition includes a phenol formaldehyde resin; a bisthiosulfate; and an elastomer comprising (1) a C₄ to C₇ isoolefin-derived monomer, a non-halogenated alkylstyrene monomer, and a halogenated alkylstyrene monomer, or (2) a C₄ to C₇ isoolefin-derived monomer and a halogenated diolefin.

In at least one embodiment, a bromine-containing vulcanizate has a Mooney Viscosity (ML, 1+4@100° C.) of 75 to 92; a cross-linking level (MH-ML) of 10 dNm to 19 dNm; a modulus at 300% of 3 MPa to 10 MPa; a tensile strength at break of 7 MPa to 15 MPa; an elongation at break of 400% to 800%; and an energy at break of 3 J to 5 J.

### DETAILED DESCRIPTION

The present disclosure relates to compositions, vulcanizates thereof, and cure processes. Compositions of the present disclosure can include elastomers and a curative system that includes (1) a phenol formaldehyde resin and (2) a polyfunctional curative that is a bisthiosulfate. Compositions can be cured to form vulcanizates. Compositions (and vulcanizates thereof) of the present disclosure can provide tire curing bladders having good curing and aging properties while avoiding excessively high modulus values and relatively poor elongation.

Vulcanizates of the present disclosure can have lower 300% modulus and ultimate tensile at break, as compared to conventional vulcanizates, in addition to maintaining excellent elongation at break resulting in comparable values for energy at break, indicating good aging properties.

In addition, the state of cure (“MH-ML”) of compositions of the present disclosure can decrease with increasing levels of phenol formaldehyde resin, while increasing the levels of phenol formaldehyde resin also results in a more scorchy compound as shown by decreasing ts2 values. MH-ML is referred to as delta torque (max torque-minimum torque). This value is correlated to the state of cure, the higher the value the higher the state of cure. In addition, better tensile at break can be obtained with low levels of phenol formaldehyde resin, and higher elongation can be obtained with high levels of phenol formaldehyde resin. Vulcanizates of the present disclosure can also maintain excellent elongation after aging, however the lower phenol formaldehyde resin levels may provide better tensile at break. Accordingly, vulcanizate properties can be tuned with varying phenolic resin in a composition of the present disclosure depending on, e.g., the end use requirements.

### Definitions

A “curing bladder” is a flexible, inflatable bladder used or capable of being inflated to mold and/or cure elastomeric articles such as tires in a tire press.

The term “elastomer” as used herein refers to any polymer or combination of polymers consistent with the ASTM D1566-15 definition, incorporated herein by reference. As used herein, the term “elastomer” may be used interchangeably with the term “rubber.”

As used herein, “polymer” may be used to refer to homopolymers, copolymers, terpolymers, etc. As used herein, the term “copolymer” is meant to include polymers having two or more monomers. Polymers, in some embodiments, may be produced (1) by mixing all multiple monomers at the same time or (2) by sequential introduction of the different comonomers. The mixing of comonomers may be done in one, two, or possible three different reactors in series and/or in parallel. As used herein, when a polymer is referred to as “comprising” a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, “diolefin” refers to an unsaturated hydrocarbon having at least two unsaturated bonds between carbon atoms. While normally, a diolefin will have two double bonds, a molecule with additional double bonds or with one or more triple bonds may also function as a diolefin for purposes of the present disclosure.

The term “composition” or “blend” as used herein refers to a mixture of two or more polymers, optionally including additional materials such as curing agents. Blends may be produced by, for example, solution blending, melt mixing, or compounding in a shear mixer. A composition/blend can be cured to form a “vulcanizate”. The vulcanizate can be used as a tire curing bladder of the present disclosure.

The term “monomer” or “comonomer,” as used herein, can refer to the monomer used to form the polymer (i.e., the unreacted chemical compound in the form prior to polymerization) and can also refer to the monomer after it has been incorporated into the polymer, also referred to herein as a “[monomer]-derived unit”. Different monomers are discussed herein including C₄-C₇ isoolefin monomers, non-halogenated alkylstyrene monomers, halogenated styrene monomers, and diolefin monomers.

As used herein, “phr” means “parts per hundred parts rubber,” where the “rubber” is the total rubber content of the composition. Herein, both the elastomers (such as BIMSM) of the present disclosure and additional rubbers, when present, are considered to contribute to the total rubber content. Thus, for example, a composition having 30 parts by weight of elastomer of the present disclosure and 70 parts by weight of a second rubber (e.g., butyl rubber) may be referred to as having 30 phr elastomer and 70 phr second rubber. Other components added to the composition are calculated on a phr basis. That is, addition of 50 phr of oil means, for example, that 50 g of oil are present in the composition for every 100 g of total rubber. Unless specified otherwise, phr should be taken as phr on a weight basis.

“Mooney viscosity” as used herein is the Mooney viscosity of a polymer or polymer composition. The polymer composition analyzed for determining Mooney viscosity should be substantially devoid of solvent. For instance, the sample may be placed on a boiling-water steam table in a hood to evaporate a large fraction of the solvent and unreacted monomers, and then, dried in a vacuum oven overnight (12 hours, 90° C.) prior to testing, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-17, but with the following modifications/clarifications of that procedure. First, sample polymer is pressed between two hot plates of a compression press prior to testing. The plate temperature is 125° C.+/−10° C. instead of the 50+/−5° C. recommended in ASTM D1646-17, because 50° C. is unable to cause sufficient massing. Further, although ASTM D1646-17 allows for several options for die protection, should any two options provide conflicting results, PET 36 micron should be used as the die protection. Further, ASTM D1646-17 does not indicate a sample weight in Section 8; thus, to the extent results may vary based upon sample weight, Mooney viscosity determined using a sample weight of 21.5+/−2.7 g in the D1646-17 Section 8 procedures will govern. Finally, the rest procedures before testing set forth in D1646-17 Section 8 are 23+/−3° C. for 30 min in air; Mooney values as reported herein are determined after resting at 24+/−3° C. for 30 min in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4@125° C. or ML, 1+8@125° C.), where M is the Mooney viscosity number, L denotes large rotor (defined as ML in ASTM D1646-17), 1 is the pre-heat time in minutes, 4 or 8 is the sample run time in minutes after the motor starts, and 125° C. is the test temperature. Thus, a Mooney viscosity of 90 determined by the aforementioned method would be reported as a Mooney viscosity of 90 MU (ML, 1+8@125° C.) or 90 MU (ML, 1+4@125° C.). Alternatively, the Mooney viscosity may be reported as 90 MU; in such instance, it should be assumed that the just-described (ML, 1+4@125° C.) method is used to determine such viscosity, unless otherwise noted. In some instances, a lower test temperature may be used (e.g., 100° C.), in which case Mooney is reported as Mooney Viscosity (ML, 1+8@100° C.), or @T° C. where T is the test temperature.

### Elastomer

The elastomer described herein comprises at least one C₄ to C₇ isoolefin-derived monomer. The elastomer can be halogenated. Examples of isoolefins that may be used as a C₄ to C₇ compound include isobutylene, isobutene, 2-methyl-1-butene, 3-methyl-1-butene, 2-methyl-2-butene, and 4-methyl-1-pentene. The elastomer also includes at least one non-halogenated alkylstyrene monomer and at least one halogenated alkylstyrene monomer. Examples of non-halogenated alkylstyrene monomers include α-methylstyrene, tert-butylstyrene, and styrene units substituted in the ortho, meta, or para position with a C₁ to C₅ alkyl or branched chain alkyl. In some embodiments, the non-halogenated alkylstyrene monomer is p-methylstyrene. Examples of halogenated alkylstyrene monomers include halomethylstyrene and styrene units substituted in the ortho, meta, or para position with a halogenated C₁ to C₅ alkyl or branched chain alkyl, where the halogen may be chlorine or bromine. In some embodiments, the halogenated alkylstyrene monomer is p-halomethylstyrene, such as p-bromomethylstyrene or p-chloromethylstyrene.

The elastomers can be random elastomeric copolymers of a C₄ to C₇ isoolefin (e.g., isobutylene), a non-halogenated alkylstyrene (e.g., p-methylstyrene), and a halogenated alkylstyrene (e.g., p-bromomethylstyrene). The non-halogenated alkylstyrene and halogenated alkylstyrene monomers each can contain at least 80 wt %, such as at least 90 wt % para-isomer. Elastomers can contain the following monomer units randomly spaced along the polymer chain:

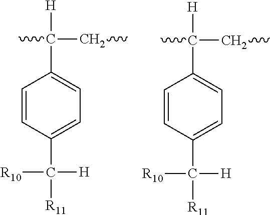

wherein R¹⁰ and R¹¹ are independently hydrogen, alkyl, such as C₁ to C₇ alkyl, or primary or secondary alkyl halides and X is a functional group such as halogen.

In some embodiments, R¹⁰ and R¹¹ are hydrogen. Up to 60 mole percent of the para-substituted styrene present in the elastomer structure may be functionalized, and in other embodiments from 0.1 to 5 mole percent. In yet another embodiment, the amount of functionalized para-substituted styrene units of an elastomer is 0.4 to 1 mole percent.

The functional group X may be halogen or a combination of a halogen and some other functional group such which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; nitrile; amino and mixtures thereof. These functionalized isoolefin copolymers, their method of preparation, methods of functionalization, and cure are more particularly disclosed in U.S. Pat. No. 5,162,445, and in particular, the functionalized amines as described below.

In some embodiments, an elastomer is an elastomeric random copolymer of isobutylene, p-methylstyrene, and p-bromomethylstyrene where the p-methylstyrene and the p-bromomethylstyrene are present in a combined amount of 0.5 to 20 weight percent (wt %) or 0.5 to 30 wt %. These halogenated elastomers are commercially available as EXXPRO™ Elastomers (ExxonMobil Chemical Company, Houston Tex.), and abbreviated as “BIMSM.” These elastomers can, if desired, have a substantially homogeneous compositional distribution such that at least 95% by weight of the polymer has a combined p-methylstyrene and p-bromomethylstyrene content within 15% of the combined p-methylstyrene and p-bromomethylstyrene content of the overall polymer.

In some embodiments, the elastomers contain from 0.1 to 7.5 mole percent (mol %) of halogenated alkylstyrene derived units relative to the combined non-halogenated and halogenated alkylstyrene derived units in the polymer. For example, the amount of bromomethyl groups is 0.2 to 3.0 mol %, 0.3 to 2.8 mol %, 0.3 to 2.0 mol %, or 0.4 to 1.0 mol %, wherein a desirable range may be any combination of any upper limit with any lower limit. Expressed another way, copolymers can contain 0.3 to 4.5 wt % of bromine, based on the weight of the polymer, 0.4 to 4 wt % bromine, or 0.6 to 1.5 wt % bromine. In at least one embodiment, the elastomer is a copolymer of C₄ to C₇ isoolefin derived units (or isomonoolefin), p-methylstyrene derived units, and p-halomethylstyrene derived units, where the p-halomethylstyrene units are present in the elastomer from 0.4 to 1.0 mol % based on the total number of p-methylstyrene and p-halomethylstyrene derived units, and where the p-methylstyrene derived units are present from 3 wt % to 15 wt % based on the total weight of the polymer, or 10 wt % to 12 wt %. The p-halomethylstyrene can be, for example, p-bromomethylstyrene.

Optionally, the elastomers can further include one or more diolefin monomers, where the C₄ to C₇ isoolefin is not the same as the diolefin. Examples of diolefins include isoprene; cis-1,3-pentadiene; trans-1,3-pentadiene; cyclopentadiene; beta-pinene; limonene; or combinations thereof.

The diene monomers can be present in the elastomers in an amount of 0.5 wt % to 10 wt % of the polymer, or 1 wt % to 8 wt %, or 2 wt % to 5 wt %.

An example elastomer can include at least one C₄ to C₇ isoolefin-derived monomer present at 60 wt % to 99 wt %, and the at least one non-halogenated alkylstyrene-derived monomer and at least one halogenated alkylstyrene-derived monomer cumulatively can be present at about 0.5 wt % to about 30 wt % with the at least one halogenated alkylstyrene-derived monomer being 0.1 mol % to 7.5 mol % of the combined content of the at least one non-halogenated alkylstyrene-derived monomer and the at least one halogenated alkylstyrene-derived monomer, and the at least one diene-derived monomer can be present at 0.5 wt % to 10 wt %.

An elastomer can have a (ML, 1+8@125° C.) Mooney viscosity less than 65, for example, 20 to 60, 25 to 50, 30 to 45, or 32 to 37.

Elastomers of the present disclosure can have a narrow molecular weight distribution (MWD), such as less than 5, such as 1 to 5, or 1.5 to 2.5.

Elastomers can be characterized by a weight average molecular weight in the range of 2,000 to 2,000,000 and a number average molecular weight of 2500 to 750,000 as determined by gel permeation chromatography. In some embodiments, it may be preferable to utilize two or more elastomers having a similar backbone, such as a low molecular weight elastomer having a weight average molecular weight less than 150,000 can be blended with a high molecular weight elastomer having a weight average molecular weight greater than 250,000, for example.

GPC description—Molecular weights can be determined by an HLC-8320 GPC system (Tosoh BioScience) equipped with an internal differential refractive index (dRI) detector, an internal UV absorbance detector (UV-8320, 254 nm absorbance), a miniDawn TREOS light scattering detector (Wyatt Technology) with three angles (45, 90, and 135°), a ViscoStar-II viscometer detector (Wyatt Technology), and a series of three of PLgel Mixed-B (Polymer Labs) with peak molecular weight (Mw) range of 580-10,000,000 g/mol. The columns can be calibrated using EasiVial polystyrene (high, medium, and low) standards (Polymer Labs). Approximately 20 mg of polymer can be dissolved in 10 mL of tetrahydrofuran (THF, VWR Co (Radnor, PA, USA)) stabilized with butylated hydroxyl toluene (BHT). With toluene as a flow marker, the solution can be filtered by using a 0.45 μm Acrodisc filter (membrane type polytetrafluoroethylene) from VWR Co (Radnor, PA, USA) and 150 μL samples can be injected by the auto injector. Testing conditions can be as follows: sample solvent, THF containing 250-400 ppm of BHT; sample concentration, 2.0 mg/mL; sample dissolution temperature, room temperature (−23° C.); sample dissolution time, 3 h minimum on dissolving wheel; GPC pump oven and column oven temperatures, 40° C.; flow rate, 1 mL/min; mobile phase solvent, THF (same as sample solvent); sample injection size, 150 μL; and sample elution time, 65 min. Astra 6.1 gel permeation chromatography software (Wyatt Technology) was used for data analysis. The Universal calibration curve methodology data are primarily used for reporting the results. For detailed understanding of the molecular weights of the elastomers, the on-line light scattering measurements, using the laser light scattering detector connected on-line with the columns and other detectors, can be used. The refractive index increment (dn/dc) value for butyl rubber, 0.113 mL/g, can be used for calculating the absolute molecular weights. Samples for light scattering can be prepared with care to avoid the presence of particulate matter. Astra 6.1 gel permeation chromatography software can be used for data analysis.

In some embodiments, the elastomers may be prepared by a slurry polymerization of the monomer mixture using a Lewis acid catalyst, followed by halogenation, such as bromination, in solution in the presence of halogen and a radical initiator such as heat and/or light and/or a chemical initiator and, optionally, followed by electrophilic substitution of bromine with a different functional moiety. In an embodiment, the elastomer may be prepared by directly functionalizing the elastomer with different functional moiety without a bromination step.

Additionally or alternatively, a composition of the present disclosure can include at least one or more of brominated butyl rubber, chlorinated butyl rubber, star-branched polyisobutylene rubber, star-branched brominated butyl(polyisobutylene/isoprene copolymer) rubber, or halogenated poly(isobutylene-co-p-methylstyrene), such as, for example, terpolymers of isobutylene derived units, p-methylstyrene derived units, and p-bromomethylstyrene derived units (BrIBMS), and the like, halomethylated aromatic interpolymers as in U.S. Pat. Nos. 5,162,445, 4,074,035, and 4,395,506; halogenated isoprene and halogenated isobutylene copolymers, polychloroprene, and the like, and mixtures of any of the above. Some embodiments of the halogenated rubber component are also described in U.S. Pat. Nos. 4,703,091 and 4,632,963.

The elastomer may include a halogenated butyl rubber component. As used herein, “halogenated butyl rubber” refers to both butyl rubber and so-called “star-branched” butyl rubber. In some embodiments, the halogenated rubber component is a halogenated copolymer of a C₄ to C₇ isoolefin and a multiolefin. In another embodiment, the halogenated rubber component is a blend of a polydiene or block copolymer, and a copolymer of a C₄ to C₇ isoolefin and a conjugated, or a “star-branched” butyl polymer. The halogenated butyl polymer of the present disclosure can thus be described as a halogenated elastomer comprising C₄ to C₇ isoolefin derived units, multiolefin derived units, and halogenated multiolefin derived units, and includes both “halogenated butyl rubber” and so called “halogenated star-branched” butyl rubber. In one embodiment, the halogenated butyl rubber is brominated butyl rubber, and in another embodiment is chlorinated butyl rubber.

A halogenated rubber component can include brominated butyl rubber, chlorinated butyl rubber, star-branched brominated butyl(polyisobutylene/isoprene copolymer) rubber, isobutylene-bromomethylstyrene copolymers such as isobutylene/meta-bromomethylstyrene, isobutylene/p-bromomethylstyrene, isobutylene/chloromethylstyrene, halogenated isobutylene cyclopentadiene, and isobutylene/p-chloromethylstyrene, and the like halomethylated aromatic interpolymers as in U.S. Pat. Nos. 4,074,035 and 4,395,506; isoprene and halogenated isobutylene copolymers, polychloroprene, and the like, and mixtures of any of the above. Some embodiments of the halogenated rubber component are also described in U.S. Pat. Nos. 4,703,091 and 4,632,963.

In another embodiment, the halogenated butyl or star-branched butyl rubber may be halogenated such that the halogenation is primarily allylic in nature. This is typically achieved by free radical bromination or free radical chlorination, or by such methods as secondary treatment of electrophilically halogenated rubbers, such as by heating the rubber, to form the allylic halogenated butyl and star-branched butyl rubber. Common methods of forming the allylic halogenated polymer are disclosed by Gardner et al. in U.S. Pat. Nos. 4,632,963, 4,649,178, and 4,703,091. Thus, some embodiments, the halogenated butyl rubber is such that the halogenated multiolefin units are primary allylic halogenated units, and wherein the primary allylic configuration is present to at least 20 mole percent (relative to the total amount of halogenated multiolefin) in some embodiments, and at least 30 mole percent in other embodiments. This arrangement can be described by the structure:

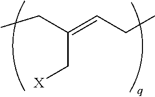

where X is a halogen, such as chlorine or bromine, and q is a positive integer.

A commercial embodiment of the halogenated butyl rubber is Bromobutyl 2222 (ExxonMobil Chemical Company) which has a Mooney viscosity of 27 to 37 (ML 1+8 at 125° C., ASTM 1646-17), and the bromine content is 1.8 to 2.2 weight percent relative to the Bromobutyl 2222. Further, cure characteristics of Bromobutyl 2222 are as follows: MH is from 28 to 40 dN·m, ML is from 7 to 18 dNm (ASTM D2084-17). Another commercial embodiment of the halogenated butyl rubber is Bromobutyl 2255 (ExxonMobil Chemical Company). Its Mooney viscosity is 41 to 51 (ML 1+8 at 125° C., ASTM 1646-17), and the bromine content is 1.8 to 2.2 weight percent. Further, cure characteristics of Bromobutyl 2255 are as follows: MH is from 34 to 48 dN·m, ML is from 11 to 21 dN·m (ASTM D2084-17).

Examples of isobutylene-isoprene copolymers, include EXXON™ BUTYL 065, EXXON™ BUTYL 065S, EXXON™ BUTYL 365, EXXON™ BUTYL 068, EXXON™ BUTYL 068S, EXXON™ BUTYL 268, EXXON™ BUTYL 268S, or combinations thereof. Examples of non-halogenated and halogenated rubbers are provided in Table 1 (all available from ExxonMobil Chemical Company), where the balance of the composition is isobutylene.

TABLE 1
Exemplary Isobutylene Based Polymers

| | Mooney | | | | | |
|---|---|---|---|---|---|---|
| | Viscosity | | Para- | | | |
| | (ML1 + 8 | Isoprene | Methylstyrene | | Halogen | Halogen |
| Elastomer | @ 125° C.) | (mol. %) | (wt. %) | Halogen | (wt. %) | (mol. %) |
| EXXON ™ | 32 | 1.05 | — | — | — | — |
| BUTYL 065 | | | | | | |
| EXXON ™ | 33 | 2.30 | — | — | — | — |
| BUTYL | | | | | | |
| 365 | | | | | | |
| EXXON ™ | 51 | 1.15 | — | — | — | — |
| BUTYL | | | | | | |
| 068 | | | | | | |
| EXXON ™ | 51 | 1.70 | — | — | — | — |
| BUTYL | | | | | | |
| 268 | | | | | | |
| EXXON ™ | 38 | 1.95 | — | Cl | 1.26 | — |
| CHLORO- | | | | | | |
| BUTYL 1066 | | | | | | |
| EXXON ™ | 32 | 1.70 | — | Br | 2.00 | — |
| BROMO- | | | | | | |
| BUTYL 2222 | | | | | | |
| EXXON ™ | 39 | 1.70 | — | Br | 2.00 | — |
| BROMO- | | | | | | |
| BUTYL 2235 | | | | | | |
| EXXON ™ | 46 | 1.70 | — | Br | 2.00 | — |
| BROMO- | | | | | | |
| BUTY 2255 | | | | | | |
| EXXON ™ | 32 | 1.70 | — | Br | 2.10 | — |
| BROMO- | | | | | | |
| BUTYL 2211 | | | | | | |
| EXXON ™ | 46 | 1.70 | — | Br | 2.10 | — |
| BROMO- | | | | | | |
| BUTYL 2244 | | | | | | |
| EXXON ™ | 32 | 1.70 | — | Br | 2.00 | — |
| BROMO- | | | | | | |
| BUTYL 7211 | | | | | | |
| EXXON ™ | 46 | 1.7 | — | Br | 2.00 | — |
| BROMO- | | | | | | |
| BUTYL 7244 | | | | | | |
| EXXON ™ | 32 | 1.70 | — | Br | 2.40 | — |
| BROMO- | | | | | | |
| BUTYL 6222 | | | | | | |
| EXXON ™ | 32 | — | — | Cl | 1.26 | — |
| CHLORO- | | | | | | |
| BUTYL 5066 | | | | | | |
| EXXPRO ® | 45 | — | 5.00 | Br | — | 0.47 |
| 3035 | | | | | | |
| EXXPRO ® | 35 | — | 5.00 | Br | — | 0.75 |
| 3433 | | | | | | |
| EXXPRO ® | 45 | — | 7.50 | Br | — | 1.20 |
| 3745 | | | | | | |
| EXXPRO ® | 35 | — | 10 | Br | — | 0.85 |
| 3563 | | | | | | |

In embodiments where the compositions of the present disclosure include multiple elastomers (e.g., first elastomer, second elastomer, etc.), the first elastomer can be present at about 5 phr to about 95 phr, and the second elastomer can be present at about 5 phr to about 95 phr. For example, the first elastomer can be present at about 5 phr to about 75 phr, and the second elastomer can be present at about 25 phr to about 95 phr. In another example, the first elastomer can be present at about 5 phr to about 50 phr, and the second elastomer can be present at about 50 phr to about 95 phr. In another example, the first elastomer can be present at about 10 phr to about 30 phr, and the second elastomer can be present at about 70 phr to about 90 phr. In another example, the first elastomer can be present at about 25 phr to about 95 phr, and the second elastomer can be present at about 5 phr to about 75 phr. In another example, the first elastomer can be present at about 50 phr to about 95 phr, and the second elastomer can be present at about 5 phr to about 50 phr. In another example, the first elastomer can be present at about 70 phr to about 90 phr, and the second elastomer can be present at about 10 phr to about 30 phr.

### Curing System

As used herein, the term “curing system” refers to the combination of the curative agents. Examples of curative agents include sulfur, metals, metal oxides such as zinc oxide, peroxides, organometallic compounds, radical initiators, fatty acids, accelerators, and any other suitable curing agent.

The curing bladders of the present disclosure are formed by an elastomeric composition produced by curing the elastomers described herein with a curative system that includes (1) a phenol formaldehyde resin and (2) a bisthiosulfate. Optionally, metal oxides and/or additional curing agents can be further included in the curative system.

The phenol formaldehyde resin, which is an accelerator, can be present at 0.1 phr to 7.5 phr, or 0.1 phr to 5 phr, or 0.1 phr to 3 phr, or 0.5 phr to 2 phr, or 1 phr to 2 phr. In some embodiments, a phenol formaldehyde resin has low levels of methylol content or high levels of methylol content. In some embodiments, a phenol formaldehyde resin has a methylol content of about 4 wt % to about 12 wt %, such as about 5 wt % to about 10 wt %, such as about 6 wt % to about 8 wt %, alternatively about 8 wt % to about 12 wt %, such as about 9 wt % to about 11 wt %. Phenolic OH can be determined by titration, and the total hydroxyl group (phenolic OH+methylol group) and can be quantified by FT-IR. The difference between total OH and phenolic OH provides methylol content. Examples of phenol formaldehyde resins include alkyl phenol formaldehyde resins such as SP1045™ (octyl phenol formaldehyde resin having a methylol content of 8 wt % to 11 wt %, available from Schenectady International, Inc. of Schenectady, NY), SP1044™ (octyl phenol formaldehyde resin having a methylol content of 7.5 wt % to 9.5 wt %, available from Schenectady International, Inc. of Schenectady, NY), SP1055™ (brominated octyl phenol formaldehyde resin, available from Schenectady International, Inc. of Schenectady, NY), HRJ-10518™ (octyl phenol formaldehyde resin having a methylol content of 6 wt % to 9 wt %, available from Schenectady International, Inc. of Schenectady, NY), or combinations thereof.

Base-catalysed phenol formaldehyde resins are made by condensing a phenol with formaldehyde in the presence of base. An example of a phenol formaldehyde resin is shown below:

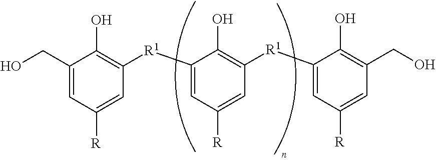

where each instance of R¹ is independently methylene (—CH₂—) or dimethylene ether (—CH₂—O—CH₂—); and n is an integer of 0 to 10, such as 1 to 5. In some embodiments, n is an integer sufficiently high such that the resin is a solid. Each instance of R is independently substituted or unsubstituted alkyl, substituted or unsubstituted cycloalkyl, substituted or unsubstituted cycloalkylalkyl, substituted or unsubstituted aryl, or substituted or unsubstituted aralkyl. R may have up to about twelve carbon atoms, such as up to 8 carbon atoms. In some embodiments, R is methyl, tert-butyl, or tert-octyl groups. See U.S. Pat. No. 2,701,895 for further examples.

The bisthiosulfate can be present at 0.1 phr to 7.5 phr, or 0.1 phr to 3 phr, or 0.5 phr to 2 phr, or 1 phr to 2 phr. A bisthiosulfate can be represented by the formula Z¹-R¹-Z², where R¹ is substituted or unsubstituted C₁ to C₁₅ alkyl, substituted or unsubstituted C₂ to C₁₅ alkenyl, or substituted or unsubstituted C₆ to C₁₂ cyclic aromatic moiety; and Z¹ and Z² are independently a thiosulfate group. In some embodiments, R1 is selected from methylene, dimethylene, trimethylene, tetramethylene, pentamethylene, hexamethylene, heptamethylene, octamethylene, and nonamethylene. Thiosulfate groups can include any suitable countercation, such as an alkali metal countercation, such as sodium or potassium. So-called bisthiosulfate compounds are an example of a class of polyfunctional compounds included in the above formula. Non-limiting examples of such polyfunctional curatives is hexamethylene bis(sodium thiosulfate).

Compositions of the present disclosure can include one or more additional accelerators. Additional accelerators may include mercaptobenzothiazole disulfide (MBTS), stearic acid, diphenyl guanidine (DPG), tetramethylthiuram disulfide (TMTD), N-t-butyl-2-benzothiazole sulfenamide (TBBS), N-cyclohexyl-2-benzothiazole-sulfenamide (CBS), thioureas, or combinations thereof. One or more additional accelerator can be present in a composition independently at 0.1 phr to 5 phr, such as 0.5 phr to 4 phr, such as 1 phr to 3 phr.

Metal oxides can act as curing agents in the composition. Examples of metal oxides include zinc oxide, calcium oxide, lead oxide, magnesium oxide, or combinations thereof. When included, the one or more metal oxide can be present independently at 0.01 phr to 5.0 phr, such as 0.1 phr to 4 phr, such as 1 phr to 3 phr, alternatively 0.01 phr to 0.5 phr, alternatively 2 phr to 4 phr.

The metal oxide can be used alone or in conjunction with its corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines, or derivatives thereof, or combinations thereof.

### Other Additives

The compositions of the present disclosure may also contain other additives such as fillers, dyes, pigments, antioxidants, heat and light stabilizers, plasticizers, oils, and/or other ingredients.

Examples of fillers include calcium carbonate, clay, mica, silica, silicates, talc, titanium dioxide, aluminum oxide, starch, wood flour, carbon black (e.g., N110 to N990 per ASTM D1765-17, such as N330), or combinations thereof. The fillers may be any size and typically range, for example, in the tire industry, from 0.0001 μm to 100 μm. When included, fillers can be present individually at 10 phr to 100 phr, or 25 phr to 80 phr, or 30 phr to 70 phr.

For example in tire bladder formulations, high structure carbon black ISAF (e.g., N220 per ASTM D1765-17) or HAF (e.g., N330 per ASTM D1765-17) can give a good balance of properties and can be used in bladder at levels of 40 phr to 60 phr. Other alternative types of carbon black are the GPF grades which show improved air aging, though ISAF grades have better steam aging properties. Acetylene black compounds in combination with, for example, N330 have good thermal conductivity which may reduce tire curing time. However, acetylene black may be difficult to disperse in the butyl rubber compound. Generally, a lower loading of carbon black (e.g., 35 phr) gives better air aging and higher loading of carbon black (e.g., 65 phr) gives better steam aging.

As used herein, silica refers to any type or particle size silica or another silicic acid derivative, or silicic acid, processed by solution, pyrogenic, or like methods, including untreated, precipitated silica, crystalline silica, colloidal silica, aluminum or calcium silicates, fumed silica, and the like. Precipitated silica can be conventional silica, semi-highly dispersible silica, or highly dispersible silica.

The compositions of the present disclosure may also include clay as a filler. The clay may be, for example, montmorillonite, nontronite, beidellite, vokoskoite, laponite, hectorite, saponite, sauconite, magadite, kenyaite, stevensite, vermiculite, halloysite, aluminate oxides, hydrotalcite, or mixtures thereof, optionally, treated with modifying agents. The clay may contain at least one silicate. Alternatively, the filler may be a layered clay, optionally, treated or pre-treated with a modifying agent such as organic molecules; the layered clay may comprise at least one silicate.

Depending on the equipment, resin cure bladder may be difficult to mix and process. To facilitate good dispersion and flow properties, it may be beneficial to use process aids such as organosilicone compounds. There are several commercially available process aids such as organosilicones and calcium fatty acid soaps suitable for curing bladder. Other processing aids may be used, including mineral oil, castor oil, hydrocarbon resins and microcrystalline waxes.

Blending of the fillers, additives, and/or curing system components may be carried out by combining the desired components and the elastomers of the present disclosure in any suitable mixing device such as a BANBURY™ mixer, BRABENDER™ mixer or an extruder and performed at temperatures of 120° C. to 300° C. under conditions of shear sufficient to allow the components to become uniformly dispersed within the elastomer to form the elastomeric compositions thereof described herein.

Blends with Secondary Rubber

The compositions of the present disclosure can also optionally include one or more secondary rubbers in addition to the brominated isobutylene styrene elastomers

When included, the secondary rubber can be included in the compositions (and optionally the additional additives) at 0.5 phr to 30 phr, or 1 phr to 25 phr, or 5 phr to 20 phr, or 10 phr to 15 phr.

In some embodiments, a secondary rubber can be natural rubber, polyisoprene rubber, poly(styrene-co-butadiene) rubber (SBR), polybutadiene rubber (BR), styrene-isoprene-butadiene rubber (SIBR), ethylene-propylene rubber (EPM), ethylene-propylene-diene rubber (EPDM), including halogenated versions of the foregoing, polysulfide, nitrile rubber, propylene oxide polymers, halobutyl rubber, brominated isobutylene-isoprene-p-methylstyrene terpolymer, star-branched butyl rubber and halogenated star-branched butyl rubber. Many of these rubbers are described by Subramaniam in RUBBER TECHNOLOGY 179-208 (M. Morton, Chapman & Hall 1995), THE VANDERBILT RUBBER HANDBOOK 105-122 (R. F. Ohm ed., R. T. Vanderbilt Co., Inc. 1990), or E. Kresge and H. C. Wang in 8 KIRK-OTHMER ENCYCLOPEDIA OF CHEMICAL TECHNOLOGY 934-955 (John Wiley & Sons, Inc. 4th ed. 1993).

Natural rubbers can include Malaysian rubber such as SMR CV, SMR 5, SMR 10, SMR 20, and SMR 50 and mixtures thereof, wherein the natural rubbers have a Mooney viscosity at 100° C. (ML 1+4) of 30 to 120, such as 40 to 65. The Mooney viscosity test referred to herein is in accordance with ASTM D1646-17.

Polybutadiene rubber (BR) can have a Mooney viscosity as measured at 100° C. (ML 1+4) of 35 to 70, such as 40 to 65, such as 45 to 60. A desirable rubber is high cis-polybutadiene (cis-BR). By “cis-polybutadiene” or “high cis-polybutadiene,” it is meant that 1,4-cis polybutadiene is used, where the amount of cis component is at least 95%. An example of a high cis-polybutadiene commercial product used in the composition is BUDENE™ 1207 (available from Goodyear Chemical).

Secondary rubbers of ethylene and propylene derived units such as EPM and EPDM are also suitable in compositions of the present disclosure. Examples of suitable comonomers in making EPDM are ethylidene norbornene, 1,4-hexadiene, dicyclopentadiene, as well as others. A suitable ethylene-propylene rubber is commercially available as VISTALON™ (ExxonMobil Chemical Company).

### Composition/Vulcanizate Properties

Compositions of the present disclosure after curing (i.e., as a vulcanizate) can have an air impermeability, such as having an oxygen transmission rate of 0.300 (mm)·(cc)/[m²·day·mmHg] at 40° C. or lower as measured on compositions or articles as described herein, or 0.250 (mm)·(cc)/[m²·day·mmHg] at 40° C. or lower, or 0.220 (mm)·(cc)/[m²·day·mmHg] at 40° C. or lower, or 0.210 (mm)·(cc)/[m²·day·mmHg] at 40° C. or lower, or 0.200 (mm)·(cc)/[m²·day·mmHg] at 40° C. or lower. For example, the vulcanizates formed into articles like tire bladders can have an oxygen transmission rate of 0.150 to 0.300 (mm)·(cc)/[m²·day·mmHg] at 40° C., or 0.155 to 0.250 (mm)·(cc)/[m²·day·mmHg] at 40° C., or 0.160 to 0.200 (mm)·(cc)/[m²·day·mmHg] at 40° C. as measured on compositions or articles as described herein. Oxygen transmission rate can be tested using ASTM D 3985-05 and an OX-TRAN®2/61 MJ module (an oxygen transmission rate test system, available from Mocon, Inc.).

The compositions (vulcanizates thereof) can have a Mooney Viscosity (ML, 1+4@100° C.), of 75 to 92, or 77 to 90, or 80 to 88. Mooney Viscosity (ML, 1+4@100° C.) can be measured as described above.

The compositions (vulcanizates thereof) can have a cross-linking level (MH-ML) of 10 dNm to 19 dNm, such as 12 dNm to 15 dNm, alternatively 15 dNm to 18 dNm.

The compositions (vulcanizates thereof) can have a modulus at 300% elongation (modulus at 300%). For example, the compositions after curing using cure time obtained from Moving Die Rheometer (MDR) test at tc90+2@190° C. can have a modulus at 300% of 3 MPa to 10 MPa, or 4 MPa to 6 MPa, alternatively 6 MPa to 9.5 MPa, or 8 MPa to 9.5 MPa. In another example, the compositions after curing using cure time obtained from Moving Die Rheometer (MDR) test at tc90+2@190° C. and aging in air at 177° C. for 2 days can have a modulus at 300% of 3 MPa to 10 MPa, or 4 MPa to 6 MPa, alternatively 6 MPa to 9.5 MPa, or 8 MPa to 9.5 MPa. Modulus at 300% can be measured based on ISO 37.

The compositions (vulcanizates thereof) can have a tensile strength at break. For example, the compositions after curing using cure time obtained from Moving Die Rheometer (MDR) test at tc90+2@190° C. can have a tensile strength at break of 11 MPa to 17 MPa, or 13 MPa to 16.5 MPa, or 14.7 MPa to 16 MPa. In another example, the compositions after curing using cure time obtained from Moving Die Rheometer (MDR) test at tc90+2@190° C. and aging in air at 177° C. for 2 days can have a tensile strength at break of 7 MPa to 15 MPa, or 8 MPa to 12 MPa, alternatively 12 MPa to 14 MPa. Tensile strength at break can be measured based on ISO 37.

The compositions (vulcanizates thereof) can have an elongation at break. For example, the compositions after curing using cure time obtained from Moving Die Rheometer (MDR) test at tc90+2@190° C. can have an elongation at break of 400% to 900%, or 500% to 700%, such as 600% to 700%, alternatively 700% to 850%. In another example, the compositions after curing using cure time obtained from Moving Die Rheometer (MDR) test at tc90+2@190° C. and aging in air at 177° C. for 2 days can have an elongation at break of 400% to 800%, or 400% to 600%, alternatively 600% to 750%. Elongation to break can be measured based on ISO 37.

The compositions (vulcanizates thereof) can have an energy at break. For example, the compositions after curing using cure time obtained from Moving Die Rheometer (MDR) test at tc90+2@190° C. and aging in air at 177° C. for 2 days can have an energy at break of 3 J to 6 J, such as 4 J to 5 J, alternatively 5 J to 6 J. Energy at break can be measured based on ISO 37.

### End Uses

The compositions of the present disclosure may be extruded, compression molded, blow molded or injection molded into various shaped articles including fibers, films, industrial parts such as automotive parts, appliance housings, consumer products, packaging and the like. The resulting articles exhibit both high impact strength and low vapor permeability.

A vulcanizate of a composition of the present disclosure can be useful for air barriers such as bladders, air spring sleeves, and automotive (including truck, commercial and/or passenger) or aircraft innerliners and innertubes. Other useful goods that can be made using compositions (or vulcanizates thereof) of the present disclosure include hoses, seals, belts, molded goods, cable housing, and other articles disclosed in THE VANDERBILT RUBBER HANDBOOK, p 637-772 (R. F. Ohm, ed., R. T. Vanderbilt Company, Inc. 1990).

Suitable elastomeric compositions for such articles as air barriers, and more particularly tire curing bladders, innerliners, tire innertubes, and air sleeves, including gaskets and ring structures, can be prepared by using mixing techniques such as with a Banbury™ mixer. The sequence of mixing and temperatures employed are well known to the skilled rubber compounder, the objective being the dispersion of fillers, activators, and curatives in the composition without excessive heat buildup.

### Methods

The compositions of the present disclosure may be compounded (mixed) by any conventional means known to those skilled in the art. The mixing may occur in a single step or in multiple stages. For example, the components (elastomer, phenol formaldehyde resin, polyfunctional curative) are typically mixed in at least two stages, namely at least one non-productive stage followed by a productive mixing stage. The curatives (phenol formaldehyde resin, polyfunctional curative) are typically mixed in the final stage, which is conventionally called the “productive” mix stage. In the productive mix stage, the mixing typically occurs at a temperature, or ultimate temperature, lower than the mix temperature(s) of the preceding non-productive mix stage(s). The elastomers, secondary rubbers, polymer additives, silica and silica coupler, and carbon black, if used, are generally mixed in one or more non-productive mix stages. The terms “non-productive” and “productive” mix stages are well known to those having skill in the rubber mixing art.

In one embodiment, the carbon black is added in a different stage from zinc oxide and other cure activators and accelerators. In another embodiment, antioxidants, antiozonants, and processing materials are added in a stage after the carbon black has been processed with the elastomers, and zinc oxide is added at a final stage to maximize the compound modulus. In a further embodiment, mixing with the clays are performed by techniques known to those skilled in the art, where the clay is added to the polymer at the same time as the carbon black. In other embodiments, additional stages may involve incremental additions of one or more fillers.

In another embodiment, mixing of the components may be carried out by combining the elastomers, filler and clay in any suitable mixing device such as a two-roll open mill, BRABENDER™ internal mixer, BANBURY™ internal mixer with tangential rotors, Krupp internal mixer with intermeshing rotors, or a mixer/extruder, by techniques known in the art. Mixing may be performed at temperatures up to the melting point of the elastomer(s) used in the composition in one embodiment, or 40° C. to 250° C., or 100° C. to 200° C. Mixing should generally be conducted under conditions of shear sufficient to allow any clay to exfoliate and become uniformly dispersed within the elastomer(s).

Typically, from 70% to 100% of the elastomer or elastomers is first mixed for 20 to 90 seconds, or until the temperature reaches from 40° C. to 75° C. Then, approximately 75% of the filler, and the remaining amount of elastomer, if any, can be added to the mixer, and mixing continues until the temperature reaches from 90° C. to 150° C. Next, the remaining filler is added, as well as the processing aids, and mixing continues until the temperature reaches from 140° C. to 190° C. The masterbatch mixture is then finished by sheeting on an open mill and allowed to cool, for example, to from 60° C. to 100° C. when the remaining components of the curing system may be added to produce a final batch mix.

The curing bladder is a cylindrical bag usually made from the final batch mix.

Generally, the final batch mix is molded into the shape of a tire curing bladder and cured (to form a vulcanizate). Compositions of the present disclosure can be cured for less than 30 min (e.g., 15 min to 30 min, or 20 min to 25 min) at 170° C. to 200° C. In another embodiment, the curing time can be 45 min to 90 min (e.g., 50 min to 80 min, or 60 min to 70 min), and the curing temperature can be 120° C. to 150° C. (e.g., 125° C. to 145° C., or 130° C. to 140° C.).

Generally, with lower temperatures longer curing times are needed. As described, the curing temperature as compared to butyl rubber compositions can be about the same, but the curing time can be reduced by at least half. Alternatively, the curing time can be the same to a bit longer and be at a lower temperature. In either instance, energy costs are reduced.

In use, a collapsible bladder is mounted in the lower section of a tire curing press and forms a part of the press and mold assembly. The “green” unvulcanized tire is positioned over the bladder in the bottom half of the mold. When the mold is closed, pressurized steam, air, hot water, or inert gas (nitrogen) is introduced systematically (pre-programmed) into the bladder to provide internal heat and pressure for the tire shaping and curing process. Two typical types of tire curing presses that require bladders are: (1) SLIDEBACK™ (tire curing press and loader, available from NRM) type press that typically uses an AUTOFORM™ (mechanical tire press, available from Bagwell) bladder and (2) TILTBACK™ (mechanical tire press, available from Bag-O-Matic) type press that typically uses a Bag-O-Matic bladder. Examples of tire curing bladders include wall curing bladders for passenger cars, light trucks and commercial trucks, toroidal curing bladders, closed end curing bladders, and the like.

Tire cure cycles may include a steam-high pressure hot water cure cycle, a steam-inert gas cure process, and/or a steam-steam cure cycle. Dome temperatures can reach 190° C. (mold sidewall plates at 180° C.), and the bladder temperatures can reach up to 220° C. An exemplary simple steam-hot water cure cycle time for a truck tire might be (1) steam 12 minutes; (2) high pressure hot water 30 minutes; (3) cold water flush 4 minutes; and (4) drain 30 seconds, for a total cure time of 46:30. The compositions (vulcanizates thereof) of the present disclosure can be used for the curing bladder since they generally meet the basic properties: (1) a homogeneous, well mixed composition for ease of processing (mixing, extruding, and mold flow); (2) excellent heat aging resistance; (3) resistance to degradation due to saturated steam or high pressure hot water, or inert gas; (4) excellent flex and hot tear resistance; (5) low tension and compression set that maintains high elongation properties; and/or (6) impermeability to air, inert gas, and water vapor. Attainment of these properties provides a curing bladder to achieve an adequate service life (i.e., number of tire cure cycles), which is commonly referred to as the pull-point. The pull-point is where the bladder is removed before failure; thereby preventing failures during tire cure cycles, which can lead to the loss of tires during production. As compared to tire bladders composed of butyl rubber compositions, the tire bladders of the present disclosure can have an increased pull-point.

### ADDITIONAL ASPECTS

The present disclosure provides, among others, the following aspects, each of which may be considered as optionally including any alternate aspects.
Clause 1. A composition comprising:
   a phenol formaldehyde resin;
   a bisthiosulfate; and
   an elastomer comprising (1) a C₄ to C₇ isoolefin-derived monomer, a non-halogenated alkylstyrene monomer, and a halogenated alkylstyrene monomer, or (2) a C₄ to C₇ isoolefin-derived monomer and a halogenated diolefin.
Clause 2. The composition of Clause 1, wherein the C₄ to C₇ isoolefin-derived monomer is isobutylene.
Clause 3. The composition of Clauses 1 or 2, wherein the non-halogenated alkylstyrene monomer is par-methylstyrene and the halogenated alkylstyrene monomer is para-bromomethylstyrene.
Clause 4. The composition of any of Clauses 1 to 3, wherein the par-methylstyrene and the para-bromomethylstyrene are present in a combined amount of 0.5 wt % to 20 wt % based on the weight of the elastomer, and the composition has a bromine content of 0.6 wt % to 1.5 wt % based on the weight of the elastomer.
Clause 5. The composition of any of Clauses 1 to 4, wherein the elastomer has a Mooney viscosity (ML, 1+8@125° C.) of 20 to 60, a molecular weight distribution of 1 to 5, a weight average molecular weight of 2,000 g/mol to 2,000,000 g/mol, and a number average molecular weight of 2,500 g/mol to 750,000 g/mol.
Clause 6. The composition of any of Clauses 1 to 5, wherein the composition further comprises a carbon black and a metal oxide.
Clause 7. The composition of any of Clauses 1 to 6, wherein the metal oxide is zinc oxide. Clause 8. The composition of any of Clauses 1 to 7, wherein the phenol formaldehyde resin is present at 0.5 phr to 5 phr and has a methylol content of 6 wt % to 11 wt %.
Clause 9. The composition of any of Clauses 1 to 8, wherein the phenol formaldehyde resin has a methylol content of 6 wt % to 9 wt %.
Clause 10. The composition of any of Clauses 1 to 9, wherein the phenol formaldehyde resin is represented by the formula:

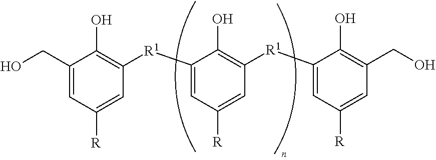

wherein each instance of R¹ is independently methylene (—CH₂—) or dimethylene ether (—CH₂—O—CH₂—), n is an integer of 0 to 10, and each instance of R is independently substituted or unsubstituted alkyl, substituted or unsubstituted cycloalkyl, substituted or unsubstituted cycloalkylalkyl, substituted or unsubstituted aryl, or substituted or unsubstituted aralkyl.
Clause 11. The composition of any of Clauses 1 to 10, wherein each instance of R is tert-octyl.
Clause 12. The composition of any of Clauses 1 to 11, wherein the halogenated diolefin is bromoisoprene.
Clause 13. The composition of any of Clauses 1 to 12, wherein the halogenated diolefin is chloroisoprene.
Clause 14. The composition of any of Clauses 1 to 13, wherein the bisthiosulfate is present at 0.1 phr to 7.5 phr and is represented by the formula:

Z¹-R¹-Z²

wherein R¹ is substituted or unsubstituted C₁ to C₁₅ alkyl, substituted or unsubstituted C₂ to Cis alkenyl, or substituted or unsubstituted C₆ to C₁₂ cyclic aromatic moiety, and Z¹ and Z² are independently a thiosulfate group.
Clause 15. The composition of any of Clauses 1 to 14, wherein R¹ of the bisthiosulfate is selected from the group consisting of methylene, dimethylene, trimethylene, tetramethylene, pentamethylene, hexamethylene, heptamethylene, octamethylene, and nonamethylene.
Clause 16. The composition of any of Clauses 1 to 15, wherein R¹ of the bisthiosulfate is hexamethylene.
Clause 17. The composition of any of Clauses 1 to 16, wherein the bisthiosulfate is hexamethylene bis(sodium thiosulfate).
Clause 18. The composition of any of Clauses 1 to 17, wherein the composition further comprises a processing aid selected from organosilicone compounds, mineral oil, castor oil, hydrocarbon resins and microcrystalline waxes, or a combination thereof.
Clause 19. A bromine-containing vulcanizate having:
   a Mooney Viscosity (ML, 1+4@100° C.) of 75 to 92;
   a cross-linking level (MH-ML) of 10 dNm to 19 dNm;
   a modulus at 300% of 3 MPa to 10 MPa;
   a tensile strength at break of 7 MPa to 15 MPa;
   an elongation at break of 400% to 800%; and
   an energy at break of 3 J to 5 J.
Clause 20. The vulcanizate of Clause 19, wherein the cross-linking level is 12 dNm to 15 dNm.
Clause 21. The vulcanizate of Clauses 19 or 20, wherein the modulus at 300% is 4 MPa to 6 MPa.
Clause 22. The vulcanizate of any of Clauses 1 to 21, wherein the modulus at 300% is 8 MPa to 9.5 MPa.
Clause 23. The vulcanizate of any of Clauses 1 to 22, wherein the tensile strength at break is 8 MPa to 12 MPa.
Clause 24. The vulcanizate of any of Clauses 1 to 23, wherein the tensile strength at break is 12 MPa to 14 MPa.
Clause 25. The vulcanizate of any of Clauses 1 to 24, wherein the elongation at break is 400% to 600%.
Clause 26. The vulcanizate of any of Clauses 1 to 25, wherein the elongation at break is 600% to 750%.
Clause 27. The vulcanizate of any of Clauses 1 to 26, wherein the energy at break is 5 J to 6 J.

### EXAMPLES

It has been discovered that the use of heat-reactive octylphenol formaldehyde resin that contains methylol groups as a secondary curing agent in addition to 1,6-hexamethylene-bis(sodium thiosulfate) (HTS) provides excellent cure and aging properties for severe applications (such as those experienced by a tire curing bladder) while avoiding excessively high modulus values and relatively poor elongation.

In the following examples, several brominated poly(isobutylene-co-p-methylstyrene) (BIMS) with varying benzylic bromide contents were obtained by physical blending of high and low bromine containing polymer samples. The compositions and Mooney viscosities of the various polymers used in the examples are listed in Table 1.

TABLE 1
poly(isobutylene-co-para-methylstyrene) (“BIMSM”)
samples used in the examples

| | PMS | Br-PMS | Mooney Viscosity |
|---|---|---|---|
| Polymer | Content (mole %) | Content | (ML 1 + 8@125 C.) |
| Exxpro 1 | 2.06 | 0.47 | 46.6 |
| Exxpro 2 | 1.9 | 0.4 | 43.7 |
| Exxpro 3 | 2.17 | 0.28 | 45.8 |
| Exxpro 4* | 2.13** | 0.34** | 46.1** |

**not measured.
Values estimated based on blend ratio

Masterbatches were prepared by standard methods using a Brabender Intelli-torque internal mixer with the Prep-mixer head. Unless otherwise stated, the masterbatches included 100 parts by weight BIMSM or other rubber, 50 phr N330 carbon black, 8 phr microcrystalline wax blended in a Banbury mixer until the temperature reached 160-165° C. Cure additives were blended into the masterbatch on a second pass in a Brabender Intelli-torque internal mixer with the Roller type 6 blades keeping the temperature below 100° C.

Cure characteristics were evaluated using an Alpha Technologies MDR rheometer 2000 at 190° C. and 1° arc. Delta torque (MH-ML) is the maximum torque (MH) minus minimum torque (ML). Scorch safety (ts2) is the time at which torque rises 2 torque units (dNm) above ML. tc(90) is the time to 90 percent of delta torque above minimum torque.

Stress/Strain Measurements on test specimens using ASTM D4482 die. Specimens were tested on an Instron 5565 with a long travel mechanical extensometer. The load cell and extensometer are calibrated before each day of testing with 20 mm as the gauge length. Sample information, operator name, date, lab temperature, and humidity were all recorded. Specimen thickness was measured at three places in the test area and the average value was entered when prompted. The lab temperature and humidity were measured. Specimen was carefully loaded in the grips to ensure grips clamp on the specimen symmetrically. The extensometer grips was then attached to the sample in the test area. The test was prompted to start. A pre-load of 0.1N was applied. Testing began with the crosshead at 20 inches/minute until a break is detected. 3 specimens from each sample were tested and the median values were reported.

Samples were oven aged for 48 hours at 177° C., followed by resting for 24 hours before Strain/strain measurement.

The compositions tested are summarized in Table 2. Compositions 1-4 represent the comparative examples whereby only 1,6-hexamethylene-bis(sodium thiosulfate) and zinc oxide were employed as the curative based on similar formulation as described in U.S. Pat. No. 5,698,640. Compositions 5-8 are inventive examples where the cure system was modified by addition of a heat-reactive octylphenol formaldehyde resin (also commonly referred to as phenolic resin) (SP-1045) that contains methylol groups to the existing cure system. Compositions 9 and 10 are further inventive examples where a different phenolic resin (HRJ-10518) was used in the compositions.

TABLE 2
Compositions for comparison of comparative examples to inventive examples
Composition (phr)

| INGREDIENT* | CE1 | CE2 | CE3 | CE4 | IE5 | IE6 | IE7 | IE8 | IE9 | IE10 |
|---|---|---|---|---|---|---|---|---|---|---|
| Exxpro 1 = | 100 | | | | 100 | | | | | |
| Exxpro | | | | | | | | | | |
| 3035 | | | | | | | | | | |
| Exxpro 2 = | | 100 | | | | 100 | | | | |
| Exxpro | | | | | | | | | | |
| 3035 with | | | | | | | | | | |
| low Br | | | | | | | | | | |
| Exxpro 3 | | | | 100 | | | | 100 | | 100 |
| Exxpro 4 | | | 100 | | | | 100 | | 100 | |
| N330 | 50 | 50 | 50 | 50 | 50 | 50 | 50 | 50 | 50 | 50 |
| Black | | | | | | | | | | |
| Akrowax | 8 | 8 | 8 | 8 | 8 | 8 | 8 | 8 | 8 | 8 |
| 5030 | | | | | | | | | | |
| DHT-4A | 0.25 | 0.25 | 0.25 | 0.25 | 0.25 | 0.25 | 0.25 | 0.25 | 0.25 | 0.25 |
| Duralink | 1.6 | 1.6 | 1.6 | 1.6 | 1.6 | 1.6 | 1.6 | 1.6 | 1.6 | 1.6 |
| HTS | | | | | | | | | | |
| SP-1045 | | | | | 1 | 1 | 1 | 1 | | |
| HRJ- | | | | | | | | | 1 | 1 |
| 10518 | | | | | | | | | | |
| ZnO | 2 | 2 | 2 | 2 | 2 | 2 | 2 | 2 | 2 | 2 |
| TOTAL | 162.2 | 162.2 | 162.2 | 162.2 | 163.2 | 163.2 | 163.2 | 163.2 | 163.2 | 163.2 |
| (phr) | | | | | | | | | | |

*Akrowax 5030 (a microcystallline wax) available from Akrochem; DHT-4A (a hydrotalcite or magnesium aluminum carbonate (hydrate) available from Kisuma; Duralink HTS (hexamethylene-1,6-bis(thiosulfate), disodium salt, dihydrate) available from Eastman; SP-1045 and HRJ-10518 (phenolic resins) available from SI Group.

The MDR results (Table 3) show good vulcanization properties for the inventive examples 5-10 with higher cross-linking level (MH-ML) and faster cure kinetics (ts2 and t90) versus comparative examples 1-4.

TABLE 3
MDR data @ 190 C., 1 arc for 60 min.

| | CE 1 | CE2 | CE3 | CE4 | IE5 | IE6 | IE7 | IE8 | IE9 | IE10 |
|---|---|---|---|---|---|---|---|---|---|---|
| ML | 2.96 | 2.95 | 2.94 | 2.94 | 2.87 | 2.98 | 2.89 | 2.79 | 2.99 | 2.79 |
| (dNm) | | | | | | | | | | |
| MH | 19.17 | 18.38 | 16.65 | 14.55 | 20.28 | 19.92 | 17.2 | 15.25 | 18.08 | 16.02 |
| (dNm) | | | | | | | | | | |
| MH − | 16.21 | 15.43 | 13.71 | 11.61 | 17.41 | 16.94 | 14.31 | 12.46 | 15.09 | 13.23 |
| ML | | | | | | | | | | |
| (dNm) | | | | | | | | | | |
| ts2 | 1.96 | 2.52 | 2.07 | 2.61 | 0.93 | 0.96 | 1.02 | 1.13 | 1.05 | 1.17 |
| (min) | | | | | | | | | | |
| tc90 | 15.7 | 17.7 | 21.22 | 29.99 | 3.25 | 3.39 | 3.36 | 3.57 | 3.82 | 4.15 |
| (min) | | | | | | | | | | |

The tensile properties of the vulcanizates (Table 4) show significant improvement in elongation at break for inventive examples 5-10 while maintaining excellent ultimate tensile at break and 300% modulus versus comparative examples 1-4. Both grades of phenolic resins SP-1045 (examples 7 & 8) and HRJ-10518 (examples 9 & 10) show comparable tensile properties.

TABLE 4
Tensile properties for unaged vulcanizates

| | 300% | Ultimate tensile | Elongation |
|---|---|---|---|
| Examples | Modulus | at break (Mpa) | at break (%) |
| CE1 unaged | 10.8 | 15.2 | 417 |
| CE2 unaged | 9.3 | 14.5 | 456 |
| CE3 unaged | 8.0 | 14.2 | 517 |
| CE4 unaged | 6.8 | 14.0 | 596 |
| IE5 unaged | 9.2 | 15.0 | 518 |
| IE6 unaged | 8.6 | 15.0 | 540 |
| IE7 unaged | 6.7 | 14.9 | 701 |
| IE8 unaged | 5.6 | 15.0 | 812 |
| IE9 unaged | 7.2 | 15.1 | 679 |
| IE10 unaged | 5.8 | 15.2 | 764 |

The aging properties (Table 5) of the vulcanizates were evaluated by conducting stress/strain measurements after air aging at 177° C. for 48 h. The inventive examples show lower modulus and ultimate tensile but maintain excellent elongation at break resulting in comparable values for energy at break indicating good aging properties for inventive examples versus comparative examples.

TABLE 5
Tensile properties for after aging at 177° C. for 48 h

| | 300% | Ultimate tensile | Elongation | Energy |
|---|---|---|---|---|
| Examples | Modulus | at break (Mpa) | at break (%) | at break (J) |
| CE1 aged | 12.7 | 15.2 | 362 | 4.2 |
| CE2 aged | 11.3 | 15.3 | 408 | 4.6 |
| CE3 aged | 7.8 | 13.4 | 527 | 5.4 |
| CE4 aged | 6.2 | 12.3 | 603 | 5.4 |
| IE5 aged | 8.8 | 13.2 | 459 | 4.6 |
| IE6 aged | 8.4 | 13.8 | 511 | 5.5 |
| IE7 aged | 5.9 | 11.5 | 636 | 5.9 |
| IE8 aged | 4.2 | 9.7 | 699 | 5.3 |
| IE9 aged | 5.9 | 11.1 | 610 | 5.4 |
| IE10 aged | 4.6 | 9.6 | 682 | 5.2 |

Compositions 11-14 (Table 6) examines the impact of increasing level of the phenolic resin in the compositions.

TABLE 6
Compositions for inventive examples with
increasing level of phenolic resin

| INGREDIENT* | IE11 | IE12 | IE13 | IE14 |
|---|---|---|---|---|
| Exxpro 3 | 100 | 100 | 100 | 100 |
| N330 Black | 50 | 50 | 50 | 50 |
| Akrowax 5030 | 8 | 8 | 8 | 8 |
| Duralink HTS | 1.6 | 1.6 | 1.6 | 1.6 |
| SP-1045 | 0.5 | 1 | 1.5 | 2 |
| ZnO | 0.5 | 0.5 | 0.5 | 0.5 |
| TOTAL (phr) | 160.6 | 161.1 | 161.6 | 162.1 |

*Akrowax 5030 (a microcystallline wax) available from Akrochem; Duralink HTS (hexamethylene-1,6-bis(thiosulfate), disodium salt, dihydrate) available from Eastman; SP-1045 and HRJ-10518 (phenolic resins) available from SI Group.

The MDR results (Table 7) show a surprising trend where the state of cure (MH-ML) decreased with increasing level of the phenolic resin curative. Also, increasing phenolic level resulted in a more scorchy composition as shown in decreasing ts2 values.

TABLE 7
MDR data @ 190° C., 1 arc for 60 min.

| | IE11 | IE12 | IE13 | IE14 |
|---|---|---|---|---|
| ML (dNm) | 2.78 | 2.75 | 2.73 | 2.66 |
| MH (dNm) | 16.04 | 15.49 | 14.98 | 14.39 |
| MH-ML (dNm) | 13.26 | 12.74 | 12.25 | 11.73 |
| ts2 (min) | 1.65 | 1.32 | 1.12 | 1.06 |
| tc90 (min) | 7.19 | 4.82 | 4.41 | 4.2 |

The tensile properties of the vulcanizates (Table 8) show decreasing 300% moduli which is consistent with the decreasing trend of the state of cure MH-ML shown in Table 7. All vulcanizates show excellent ultimate tensile and elongation at break where the optimum tensile is obtained with low level of phenolic resin and higher elongation is obtained with high level of phenolic resin.

TABLE 8
Tensile properties for unaged vulcanizates

| | 300% | Ultimate tensile | Elongation |
|---|---|---|---|
| Examples | Modulus | at break (Mpa) | at break (%) |
| IE11 unaged | 7.5 | 15.2 | 651 |
| IE12 unaged | 6.7 | 14.7 | 712 |
| IE13 unaged | 5.8 | 14.4 | 713 |
| IE14 unaged | 5.5 | 14.5 | 803 |

The aging properties (Table 9) of the vulcanizates were evaluated by conducting stress/strain measurement after air aging at 177° C. for 48 h. All vulcanizates maintained excellent elongation after aging, however the lower phenolic resin vulcanizates maintained better ultimate tensile properties. These examples illustrate that the vulcanizate properties can be easily tuned with varying phenolic resin in the inventive formulation depending on the application requirements.

TABLE 9
Tensile properties for vulcanizates after aging at 177° C. for 48 h

| | 300% | Ultimate tensile | Elongation | Energy |
|---|---|---|---|---|
| Examples | Modulus | at break (Mpa) | at break (%) | at break (J) |
| IE11 aged | 6.50 | 12.7 | 615 | 5.83 |
| IE12 aged | 5.49 | 11.0 | 662 | 5.97 |
| IE13 aged | 4.95 | 10.1 | 673 | 5.50 |
| IE14 aged | 4.92 | 9.5 | 672 | 5.48 |

These examples show that excellent vulcanization and vulcanizate properties can be obtained for the inventive formulation based on a combination Duralink/phenolic resin/ZnO cure system especially with the low bromine brominated poly(isobutylene-co-par-methylstyrene) polymer (“BIMSM”).

Overall, the present disclosure provides compositions, vulcanizates thereof, and cure processes. Compositions of the present disclosure can include an elastomer and a curative system that includes (1) a phenol formaldehyde resin and (2) a bisthiosulfate. Compositions can be cured to form vulcanizates. Compositions (and vulcanizates thereof) of the present disclosure can provide tire curing bladders having good curing and aging properties while avoiding excessively high modulus values and relatively poor elongation. Vulcanizates of the present disclosure can have lower 300% modulus and ultimate tensile at break, as compared to conventional vulcanizates, in addition to maintaining excellent elongation at break resulting in comparable values for energy at break, indicating good aging properties.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Numerical ranges used herein include the numbers recited in the range. For example, the numerical range “from 1 wt % to 10 wt %” includes 1 wt % and 10 wt % within the recited range.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A composition comprising:
a phenol formaldehyde resin;
a bisthiosulfate; and
an elastomer comprising (1) a C₄ to C₇ isoolefin-derived monomer, a non-halogenated alkylstyrene monomer, and a halogenated alkylstyrene monomer, or (2) a C₄ to C₇ isoolefin-derived monomer and a halogenated diolefin.

2. The composition of claim 1, wherein the C₄ to C₇ isoolefin-derived monomer is isobutylene.

3. The composition of claim 2, wherein the non-halogenated alkylstyrene monomer is para-methylstyrene and the halogenated alkylstyrene monomer is para-bromomethylstyrene.

4. The composition of claim 3, wherein the par-methylstyrene and the para-bromomethylstyrene are present in a combined amount of 0.5 wt % to 20 wt % based on the weight of the elastomer, and the composition has a bromine content of 0.6 wt % to 1.5 wt % based on the weight of the elastomer.

5. The composition of claim 1, wherein the elastomer has a Mooney viscosity (ML, 1+8@125° C.) of 20 to 60, a molecular weight distribution of 1 to 5, a weight average molecular weight of 2,000 g/mol to 2,000,000 g/mol, and a number average molecular weight of 2,500 g/mol to 750,000 g/mol.

6. The composition of claim 1, wherein the composition further comprises a carbon black and a metal oxide.

7. The composition of claim 6, wherein the metal oxide is zinc oxide.

8. The composition of claim 1, wherein the phenol formaldehyde resin is present at 0.5 phr to 5 phr and has a methylol content of 6 wt % to 11 wt %.

9. The composition of claim 8, wherein the phenol formaldehyde resin has a methylol content of 6 wt % to 9 wt %.

10. The composition of claim 8, wherein the phenol formaldehyde resin is represented by the formula: 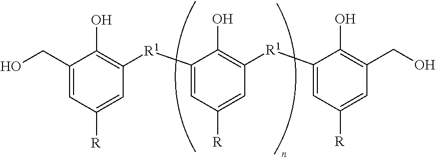
wherein each instance of R¹ is independently methylene (—CH₂—) or dimethylene ether (—CH₂—O—CH₂—), n is an integer of 0 to 10, and each instance of R is independently substituted or unsubstituted alkyl, substituted or unsubstituted cycloalkyl, substituted or unsubstituted cycloalkylalkyl, substituted or unsubstituted aryl, or substituted or unsubstituted aralkyl.

11. The composition of claim 10, wherein each instance of R is tert-octyl.

12. The composition of claim 1, wherein the bisthiosulfate is present at 0.1 phr to 7.5 phr and is represented by the formula:
Z¹-R¹-Z²
wherein R¹ is substituted or unsubstituted C₁ to C₁₅ alkyl, substituted or unsubstituted C₂ to C₁₅ alkenyl, or substituted or unsubstituted C₆ to C₁₂ cyclic aromatic moiety, and Z¹ and Z² are independently a thiosulfate group.

13. The composition of claim 12, wherein R¹ of the bisthiosulfate is selected from the group consisting of methylene, dimethylene, trimethylene, tetramethylene, pentamethylene, hexamethylene, heptamethylene, octamethylene, and nonamethylene.

14. The composition of claim 13, wherein R¹ of the bisthiosulfate is hexamethylene.

15. The composition of claim 1, wherein the bisthiosulfate is hexamethylene bis(sodium thiosulfate).

16. The composition of claim 1, wherein the composition further comprises a processing aid selected from organosilicone compounds, mineral oil, castor oil, hydrocarbon resins and microcrystalline waxes, or a combination thereof.

17. A bromine-containing vulcanizate having:
a Mooney Viscosity (ML, 1+4@100° C.) of 75 to 92;
a cross-linking level (MH-ML) of 10 dNm to 19 dNm;
a modulus at 300% of 3 MPa to 10 MPa;
a tensile strength at break of 7 MPa to 15 MPa;
an elongation at break of 400% to 800%; and
an energy at break of 3 J to 5 J.

18. The vulcanizate of claim 17, wherein the cross-linking level is 12 dNm to 15 dNm.

19. The vulcanizate of claim 17, wherein the modulus at 300% is 4 MPa to 6 MPa.

20. The vulcanizate of claim 17, wherein the modulus at 300% is 8 MPa to 9.5 MPa.

21. The vulcanizate of claim 17, wherein the tensile strength at break is 8 MPa to 12 MPa.

22. The vulcanizate of claim 17, wherein the tensile strength at break is 12 MPa to 14 MPa.

23. The vulcanizate of claim 17, wherein the elongation at break is 400% to 600%.

24. The vulcanizate of claim 17, wherein the elongation at break is 600% to 750%.

25. The vulcanizate of claim 17, wherein the energy at break is 5 J to 6 J.
